(19) United States
(12) Patent Application Publication
(10) Pub. No.: US 2024/0177653 A1
(43) Pub. Date: May 30, 2024

(54) LIGHT-EMITTING DIODE DISPLAY DEVICE AND DISPLAY METHOD OF THE SAME

(71) Applicant: Lextar Electronics Corporation, Hsinchu City (TW)

(72) Inventors: Jui Yi WU, Hsinchu City (TW); Chih Hao LIN, Hsinchu City (TW); Jian-Chin LIANG, Hsinchu City (TW)

(21) Appl. No.: 18/476,539

(22) Filed: Sep. 28, 2023

(30) Foreign Application Priority Data
Nov. 24, 2022 (TW) 111144923

(51) Int. Cl. G09G 3/32

(52) U.S. Cl. CPC G09G 3/32; G09G 2300/0452

(57) ABSTRACT

A light-emitting diode (LED) display device, includes: a plurality of displaying basic-units, each of the displaying basic-units having a plurality of sub-pixel regions, on which a plurality of red LED units, a plurality of green LED units, a plurality of blue LED units, and a plurality of white LED units are selectively provided; and a control unit, performing an image reconstruction process for an input image, thereby making each of the displaying basic-units display color, color grayscale, or black-and-white grayscale; wherein in each of the displaying basic-units, the quantity of green LED units is more than or equal to the quantity of white LED units, and the quantity of green LED units is more than the quantity of blue LED units or red LED units.

### CROSS REFERENCE TO RELATED APPLICATIONS

This application claims priority of Taiwan Patent Application No. 111144923, filed on 2022 Nov. 24, and the content of the entirety of which is incorporated by reference herein.

### BACKGROUND OF THE DISCLOSURE

### Field of the Disclosure

The present disclosure relates to a display device, and, in particular, to a light-emitting diode display device and display method of the same.

### Description of the Related Art

To display the color information of a particular pixel in an input image, a conventional light-emitting diode (LED) display device is assembled by basic-units including a red LED unit, a green LED unit, and a blue LED unit. In such cases, if three LED units are mixed to generate white light, the brightness of the white light is restricted by the respective intensities of three primary colors of light. For example, in order to maintain the color temperature of D65 standard white color, the luminous intensities of green light and blue light have to be downgraded to cooperate with the red light which usually has poor emission efficiency, thus resulting in lower brightness in a display.

### BRIEF SUMMARY OF THE DISCLOSURE

According to the present disclosure, a light-emitting diode (LED) display device comprises a plurality of displaying basic-units and a control unit. Each of the displaying basic-units has a plurality of sub-pixel regions. A plurality of red LED units, a plurality of green LED units, a plurality of blue LED units, and a plurality of white LED units may be selectively provided on the sub-pixel regions. The control unit electrically connects to the plurality of displaying basic-units. In each displaying basic-unit, the quantity of green LED units is more than or equal to the quantity of white LED units, and there are more green LED units than blue LED units or red LED units.

### BRIEF DESCRIPTION OF THE DRAWINGS

FIG. 1A is a schematic diagram showing an LED display device 1 and a plurality of displaying basic-units 10 thereof.

FIG. 1B is a schematic diagram showing a plurality of sub-pixel regions 100 in each of the displaying basic-units 10 of the FIG. 1A.

FIG. 2 is a schematic diagram showing the operation process of the LED display device 1 of the FIG. 1A.

FIG. 3 shows one configuration of the sub-pixels in the displaying basic-unit 10 according to some embodiments of the present disclosure.

FIG. 4 shows one configuration of the sub-pixels in the displaying basic-unit 10 according to some embodiments of the present disclosure.

FIG. 5 shows one configuration of the sub-pixels in the displaying basic-unit 10 according to some embodiments of the present disclosure.

FIG. 6 shows one configuration of the sub-pixels in the displaying basic-unit 10 according to some embodiments of the present disclosure.

FIG. 7 shows one configuration of the sub-pixels in the displaying basic-unit 10 according to some embodiments of the present disclosure.

FIG. 8 shows one configuration of the sub-pixels in the displaying basic-unit 10 according to some embodiments of the present disclosure.

FIG. 9 shows an exemplary embodiment of arranging an infrared sensor in the displaying basic-unit 10.

### DETAILED DESCRIPTION OF THE DISCLOSURE

In order to make the above-mentioned and other objects, features, and advantages of the present disclosure more obvious and easier to understand, some embodiments are enumerated below, and described in detail in conjunction with the accompanying drawings, as follows.

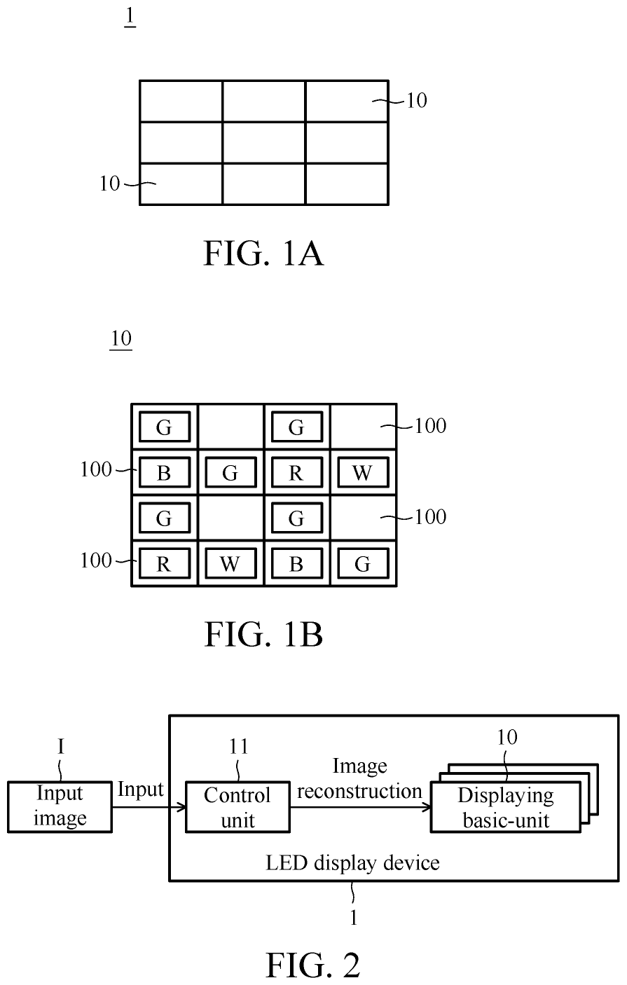

Referring to FIG. 1A and FIG. 1B, FIG. 1A is a schematic diagram showing an LED display device 1 and a plurality of displaying basic-units 10 thereof, and FIG. 1B is a schematic diagram showing a plurality of sub-pixel regions 100 in each displaying basic-unit 10 of FIG. 1A. As shown in FIG. 1A, The LED display device 1 is divided into a plurality of displaying basic-units 10 which are substantially the same in size. As shown in FIG. 1B, each of the displaying basic-units 10 can be further divided into a plurality of sub-pixel regions 100 of substantially the same size. In this embodiment, the LED display device 1 may be a display with LEDs in millimeter scale (i.e., Mini LED Display) or micrometer scale (i.e., Micro LED Display).

Any of red LED unit R, green LED unit G, blue LED unit B, and white LED unit W can be selectively provided on each of the sub-pixel regions 100. In addition, a portion of the sub-pixel regions 100 of the displaying basic-unit 10 may be reserved without any LED unit provided thereon. In FIG. 1B, for example, the sub-pixel regions 100 with notations of R, G, B, and W represent the red, green, blue, and white LED units provided thereon, and the sub-pixel region 100 without notations of R, G, B, or W represents that no LED unit is provided thereon. By reserving a portion of the sub-pixel regions 100 in the displaying basic-unit 10 without any LED unit thereon, the cost of LED units can be reduced.

The white LED unit W can be formed by blue LED unit, purple LED unit or ultraviolet LED unit in combination with fluorescent powder. Alternatively, the white LED unit W can be formed by blue LED unit, purple LED unit, or ultraviolet LED unit in combination with Quantum Dots (QDs). The white LED units W formed in such manners have higher conversion efficiency and thus can emit white light with higher brightness.

It is noted that the white LED unit(s) W are provided in each displaying basic-unit 10. In each of the displaying basic-units 10, the quantity of green LED units G is more than or equal to the quantity of white LED units W, and the quantity of green LED units G is also more than that of blue LED units B or red LED units R. Since the human eye is more sensitive to green light, more green LED units G can make the human eye perceive more image information and improve the resolution of the display.

FIG. 2 is a schematic diagram showing the operation process of the LED display device 1 according to the present disclosure. In addition to the plurality of displaying basic-units 10 mentioned above in FIG. 1A, the LED display device 1 further comprises a control unit 11. The control unit 11 may be any integrated circuit having calculating ability, such as microprocessor, Field Programmable Gate Array (FPGA), digital circuit, or Application Specific Integrated Circuit (ASIC). The control unit 11 receives input image I and performs image reconstruction process for the input image I to display in the plurality of displaying basic-units 10. The format of the input image I can be any format, and not limited thereto. In addition, the size of the input image I has no specific restriction.

The control unit 11 performs the image reconstruction process for the input image I, and thereby makes each of the displaying basic-units 10 display colors, color grayscale, or black-and-white grayscale. In particular, the control unit 11 determines the display mode of each displaying basic-unit 10 being any of color mode, color grayscale mode, and black-and-white grayscale mode according to an input command.

Here, the control unit 11, according to the respective image regions on the input image I, controls the displaying of the white LED units W, red LED units R, green LED units G, and blue LED units B in the displaying basic-units 10 which correspond to the respective image regions, through the color mode and color grayscale mode. Here, the control unit 11, according to the respective image regions on the input image I, controls the displaying of the white LED units W in the displaying basic-units 10 which correspond to the image regions, through the black-and-white grayscale mode.

For example, for the portion of the pattern, picture, text or mark on the input image I to be displayed with colors or in higher resolution, the control unit 11 can control the displaying basic-units 10 at corresponding positions to display as the color mode or color grayscale mode by the white LED units W, red LED units R, green LED units G, and blue LED units B in the displaying basic-unit 10. For the portion of the text or mark in the input image I to be displayed with black and white, or in lower resolution, the control unit 11 can control the displaying basic-units 10 at corresponding positions to display as the black-and-white grayscale mode by the white LED units W in the displaying basic-units 10.

In addition, the control unit 11 can determine the displaying basic-units 10 at the corresponding positions to display as the color mode, color grayscale mode, or black-and-white grayscale mode, according to the grayscale information, image complexity, and resolution of the input image I.

Furthermore, according to the configuration of LED units of FIG. 1B, after displaying selection, the control unit 11 executes mathematic conversion of the raw three-channel image information of the input image I, and reconstructs the locations to be light-up and the brightness associated with each LED unit of the displaying basic-units 10 in the corresponding positions. The raw three-channel image information of the input image I may be 24-bit information composed of 3 sets of 8-bit data (i.e., with value range from 0 to 255). In addition, the brightness of each LED unit can be set by direct-voltage modulation or drive-voltage modulation (i.e., time modulation).

The LED display device 1 may accomplish partition display mode according to the operation of the control unit 11 described above. For example, the displaying basic-units 10 in a first region of the LED display device 1 may display pictures in the color mode; the displaying basic-units 10 in a second region of the LED display device 1 may display pictures in the color grayscale mode; the displaying basic-unit 10 in a third region of the LED display device 1 may display pictures in the black-and-white grayscale mode; the first region, the second region and the third region are independent to each other. In addition, all displaying basic-units 10 of the LED display device 1 can be set to display in the same mode according to needs.

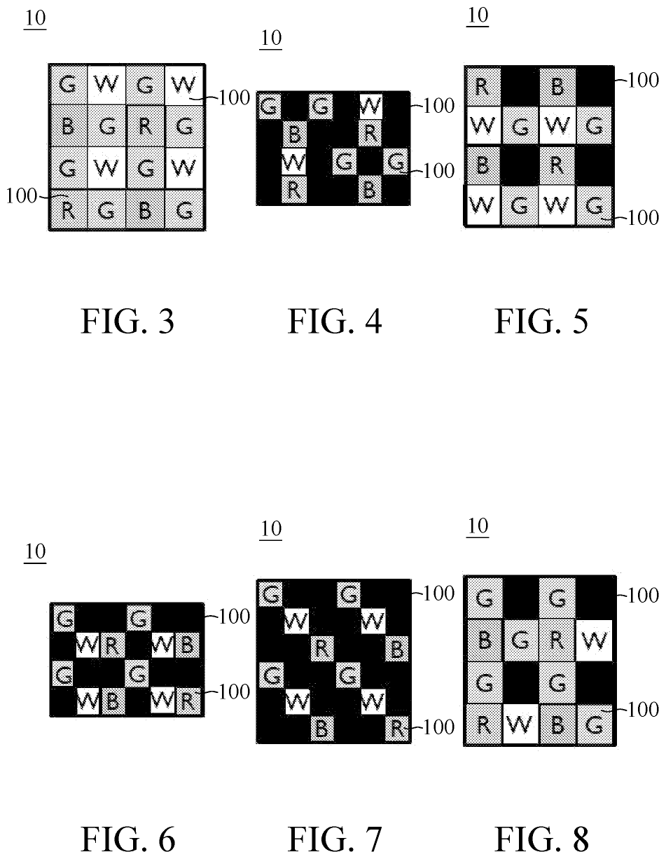

The configuration of LED units capable of supporting the control unit 11 to perform the image reconstruction is not limited to that of the LED units in FIG. 1B, and the configurations of LED units with four colors in FIG. 3 to FIG. 8 below are exemplary embodiments.

In FIG. 3, the displaying basic-unit 10 has red LED units R, green LED units G, blue LED units B, and white LED units W, and the quantity ratio of these LED units (R:G:B:W) is 1:4:1:2. To be more specific, the displaying basic-unit 10 in FIG. 3 has 16 sub-pixel regions 100 arranged in a 4×4 matrix. The respective quantities of the red LED units R, green LED units G, blue LED unit B, and white LED units W, are 2, 8, 2, and 4.

In FIG. 4, the displaying basic-unit 10 has red LED units R, green LED units G, blue LED units B, and white LED units W, and the quantity ratio of these LED units (R:G:B:W) is 1:2:1:1. To be more specific, the displaying basic-unit 10 in FIG. 4 has 24 sub-pixel regions 100 arranged in a 4×6 matrix. The respective quantities of the red LED units R, green LED units G, blue LED unit B, and white LED units W, are 2, 4, 2, and 2. Accordingly, 14 sub-pixel regions 100 do not contain LED units, thus no marking notations R, G, B, W are provided.

In FIG. 5 to FIG. 7, each displaying basic-unit 10 has red LED units R, green LED units G, blue LED units B, and white LED units W, and the quantity ratio of these LED units (R:G:B:W) is 1:2:1:2. To be more specific, the displaying basic-unit 10 in FIG. 5 has 16 sub-pixel regions 100 arranged in a 4×4 matrix; the displaying basic-unit 10 in FIG. 6 has 24 sub-pixel regions 100 arranged in a 4×6 matrix; the displaying basic-unit 10 in FIG. 7 has 36 sub-pixel regions 100 arranged in a 6×6 matrix; and the displaying basic-unit 10 in FIG. 8 has 16 sub-pixel regions 100 arranged in a 4×4 matrix.

First, the displaying basic-unit 10 in FIG. 5 has 16 sub-pixel regions 100 arranged in a 4×4 matrix. The respective quantities of the red LED units R, green LED units G, blue LED units B, and white LED units W are 2, 4, 2, and 4. Accordingly, 4 sub-pixel regions 100 do not contain LED units, thus no marking notations R, G, B, W are provided.

Then, the displaying basic-unit 10 in FIG. 6 has 24 sub-pixel regions 100 arranged in a 4×6 matrix. The respective quantities of the red LED units R, green LED units G, blue LED units B, and white LED units W are 2, 4, 2, and 4. Accordingly, 12 sub-pixel regions 100 do not contain LED units, thus no marking notations R, G, B, W are provided.

Moreover, the displaying basic-unit 10 in FIG. 7 has 36 sub-pixel regions 100 arranged in a 6×6 matrix. The respective quantities of the red LED units R, green LED units G, blue LED units B, and white LED units W are 2, 4, 2, and 4. Accordingly, 24 sub-pixel regions 100 do not contain LED units, thus no marking notations R, G, B, W are provided.

In FIG. 8, the displaying basic-unit 10 has red LED units R, green LED units G, blue LED units B, and white LED units W, and the quantity ratio of these LED units (R:G:B:W) is 1:3:1:1. To be more specific, the displaying basic-unit 10 in FIG. 8 has 16 sub-pixel regions 100 arranged in a 4×4 matrix. The respective quantities of the red LED units R, green LED units G, blue LED units B, and white LED units W are 2, 6, 2, and 2. Accordingly, 4 sub-pixel regions 100 do not contain LED units, thus no notation R, G, B, W are marked. In addition, the configuration of LED units in FIG. 8 corresponds to that in FIG. 1B.

According to the displaying basic-units 10 in FIG. 3 to FIG. 8, each displaying basic-unit 10 comprises red LED units R, green LED units G, blue LED units B, and white LED units W, and therefore the display mode of each of the displaying basic-unit 10 can be switched among color mode, color grayscale mode, and black-and-white grayscale mode.

In some embodiments of the present disclosure, under the color mode, the red, green and blue LED units (R, G, B) of the displaying basic-unit 10 are used to adjust color tone, and the white LED units (W) of the displaying basic-unit 10 are used to adjust brightness. Compared to adjusting brightness through balancing the red, green and blue LED units (R, G, B), adjusting brightness through the white LED units (W) saves more power.

Besides, in some embodiments of the present disclosure, under the color grayscale mode, the red, green and blue LED units (R, G, B) of the displaying basic-unit 10 are mixed to form white color with predetermined brightness without using white LED units. This mode can be used to display text in a pseudo-black-and-white mode.

In addition, in some embodiments of the present disclosure, under the black-and-white grayscale mode, the white LED units (W) in each displaying basic-unit 10 operate for displaying, and the red, green, and blue LED units (R, G, B) in each displaying basic-unit 10 are all in the off state. For displaying the black-and-white picture or text, this is the most power-saving mode. Compare to the color grayscale mode, black-and-white grayscale mode can achieve better image qualities such as higher contrast and acutance, especially in displaying black-and-white text.

Moreover, as shown in FIG. 4 to FIG. 8, each of the displaying basic-unit 10 has reserved a portion of sub-pixel regions 100, where no LED unit is provided with (i.e., the sub-pixel regions 100 without notations R, G, B, W marked in FIG. 4 to FIG. 8), thereby achieving the effect of saving costs for installing LED units.

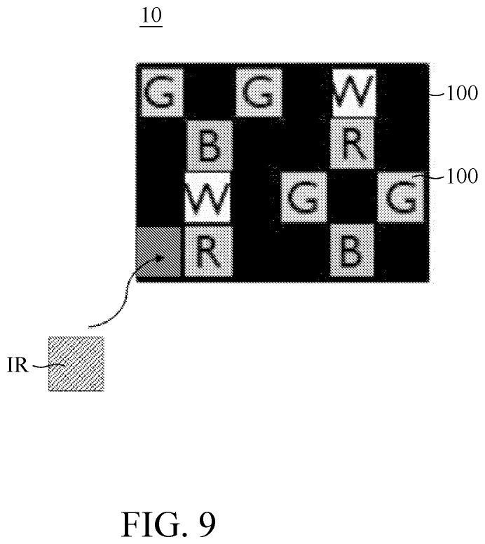

Furthermore, some of the sub-pixel regions 100 without LED units can incorporate infrared sensor IR for light sensing and distance ranging as needed. In other words, the infrared sensor IR as required can be provided to any sub-pixel regions 100 without LED unit installation in each displaying basic-unit 10 in FIG. 4 to FIG. 8. For example, an infrared sensor IR may be installed in one sub-pixel region 100 without LED unit as shown in FIG. 9.

Although the embodiments of the present disclosure have been described in detail, the present disclosure is not limited to specific embodiments, and various modifications and variations can be made within the spirit and scope of the disclosure described in the claims. Therefore, the scope for protecting the present disclosure should be defined according to the scope of the appended claims.

What is claimed is:

1. A light-emitting diode (LED) display device, comprising:
a plurality of displaying basic-units, each of the displaying basic-units having a plurality of sub-pixel regions, on which a plurality of red LED units, a plurality of green LED units, a plurality of blue LED units, and a plurality of white LED units are selectively provided; and
a control unit electrically connect to the plurality of displaying basic-units;
wherein in each of the displaying basic-units, the quantity of green LED units is more than or equal to the quantity of white LED units, and the quantity of green LED units is more than the quantity of blue LED units or red LED units.

2. The light-emitting diode display device as claimed in claim 1, wherein
in one of the displaying basic-units, the quantity ratio of the red LED units, the green LED units, the blue LED units, and the white LED units is 1:4:1:2.

3. The light-emitting diode display device as claimed in claim 1, wherein
in one of the displaying basic-units, the quantity ratio of the red LED units, the green LED units, the blue LED units, and the white LED units is 1:2:1:1.

4. The light-emitting diode display device as claimed in claim 1, wherein
in one of the displaying basic-units, the quantity ratio of the red LED units, the green LED units, the blue LED units, and the white LED units is 1:2:1:2.

5. The light-emitting diode display device as claimed in claim 1, wherein
in one of the displaying basic-units, the quantity ratio of the red LED units, the green LED units, the blue LED units, and the white LED units is 1:3:1:1.

6. The light-emitting diode display device as claimed in claim 1, wherein
in one of the displaying basic-units, some of the sub pixel regions are not provided with any LED units.

7. The light-emitting diode display device as claimed in claim 1, wherein
each of the displaying basic-units comprises one of the white LED units.

8. The light-emitting diode display device as claimed in claim 1, wherein
each of the displaying basic-units comprises one of the red LED units, one of the green LED units, one of the blue LED units, and one of the white LED units.

9. The light-emitting diode display device as claimed in claim 1, wherein
the white LED units are formed by blue, purple or ultraviolet LED units in combination with fluorescent powder.

10. The light-emitting diode display device as claimed in claim 1, wherein
the white LED units are formed by blue, purple or ultraviolet LED units in combination with Quantum Dots.

11. The light-emitting diode display device as claimed in claim 6, further comprising an infrared sensor installed on the sub-pixel region not provided with any LED units.

12. The light-emitting diode display device as claimed in claim 11, wherein
the infrared sensor is arranged at the periphery of the displaying basic-unit.

13. The light-emitting diode display device as claimed in claim 1, wherein
the sub-pixel regions are arranged as a matrix.

14. The light-emitting diode display device as claimed in claim 13, wherein
each of the sub-pixel regions is provided with one of the red LED units, the green LED units, the blue LED units, or the white LED units.

15. The light-emitting diode display device as claimed in claim 14, wherein
the LED units in two adjacent sub-pixel regions emit different colors.

16. The light-emitting diode display device as claimed in claim 13, wherein
at least one of the sub-pixel regions is not provided with any LED units.

17. A display method of the light-emitting diode (LED) display device as claimed in claim 1, the control unit performing the operations of:
receiving an image;
determining display modes of the displaying basic-units as a color, color grayscale, or black-and-white grayscale mode; and
controlling the displaying basic-units to display the image;
wherein, in the color mode, the white LED units, red LED units, green LED units, and blue LED units are operated for displaying the image;
wherein, in the color grayscale mode, the red LED units, green LED units, and blue LED units are operated for displaying the image;
wherein, in the black-and-white grayscale modes, the white LED units are operated for displaying the image.

18. The display method as claimed in claim 17, wherein
the display modes of the displaying basic-units are determined according to the image, when the displaying basic-unit is at a position corresponding to a portion of the image with colors and/or in high revolution, the display mode is determined as the color mode or color grayscale mode; when the displaying basic-units is at a position corresponding to a portion of the image in black-and-white and/or in lower resolution, the display mode is determined as the black-and-white grayscale mode.

19. The display method as claimed in claim 17, wherein
two of the displaying basic-units have different display modes.

20. The display method as claimed in claim 17, wherein
in the color mode, the red, green and blue LED units are used to adjust color tone, and the white LED units are used to adjust brightness.
